(19) United States
(12) Patent Application Publication
(10) Pub. No.: US 2024/0284210 A1
(43) Pub. Date: Aug. 22, 2024

(54) MANAGING UE CAPABILITIES IN CELLULAR COMMUNICATION SYSTEM

(71) Applicant: Nokia Technologies Oy, Espoo (FI)

(72) Inventors: Amaanat ALI, Espoo (FI); Keeth Saliya Jayasinghe LADDU, Espoo (FI); Mihai ENESCU, Espoo (FI); Tero HENTTONEN, Espoo (FI); Hiromasa UMEDA, Tokyo (JP)

(21) Appl. No.: 18/566,656

(22) PCT Filed: Jun. 4, 2021
(86) PCT No.: PCT/FI2021/050414

§ 371 Date: Dec. 3, 2023

(51) Int. Cl. H04W 24/08; H04W 24/10

(52) U.S. Cl. CPC H04W 24/08; H04W 24/10

(57) ABSTRACT

This document discloses a solution for performing radio configuration testing. According to an aspect. a method in a terminal device comprises: receiving. from a network node. a request for performing a radio configuration test for selecting operational parameters of the terminal device for a radio connection of the terminal device. the request comprising at least one information element indicating a target performance metric and at least one information element defining limitations to the operational parameters available for the radio configuration test: performing the radio configuration test by testing a plurality of different combinations of operational parameters of the terminal device, within the limitations received from the network node. and determining a performance metric of each of the plurality of different combinations of tested operational parameters: causing transmission of a test report to the network node. the test report indicating at least a combination of tested operational parameters that provides a performance metric closest to the target performance metric; and after transmitting the test report, receiving from the network node a radio configuration defining a set of operational parameters of the terminal devices selected by the network node for the radio connection.

### FIELD

Various embodiments described herein relate to the field of wireless communications and, particularly, to managing capabilities of user equipment (UE) in a modern cellular communication system.

### BACKGROUND

Capabilities of terminal devices (UEs) are increasing and diversifying with the development of new evolution versions of cellular communication systems and with merging of various radio access technologies. In the era of third or even fourth generation cellular communication systems, the number of various capabilities was relatively manageable. However, with the development of fifth generation systems, the capabilities are scaling up beyond human control. For example, a capability container (a data container describing the capabilities of a terminal device) may have even tens of thousands of octets, and the number of various device vendors is in the scale of hundreds or even more. Similarly, a radio reconfiguration message may contain several thousands of parameters that influence the operation of the terminal device. Assuming that there are usually N features that are configured with each of these 1 . . . N features comprising of M_{1 . . . N} parameter values, the combinations of optimal Mn parameter values for each of 1 . . . N features leads to M₁·M₂·M₃·M_{N} combinations (billions of potential combinations). Such complexity makes it impossible to maintain or test the true effects of every possible combination on the performance of the system. For this reason, networks utilize “default” configurations that utilize the “best tested” parameters that provide “good enough” performance that are not necessarily the most optimal ones.

### BRIEF DESCRIPTION

Some aspects of the invention are defined by the independent claims.

Some embodiments of the invention are defined in the dependent claims.

The embodiments and features, if any, described in this specification that do not fall under the scope of the independent claims are to be interpreted as examples useful for understanding various embodiments of the invention. Some aspects of the disclosure are defined by the independent claims.

According to an aspect, there is provided an apparatus for a terminal device, comprising means for performing: receiving, from a network node, a request for performing a radio configuration test for selecting operational parameters of the terminal device for a radio connection of the terminal device, the request comprising at least one information element indicating a target performance metric and at least one information element defining limitations to the operational parameters available for the radio configuration test; performing the radio configuration test by testing a plurality of different combinations of operational parameters of the terminal device, within the limitations received from the network node, and determining a performance metric of each of the plurality of different combinations of tested operational parameters; causing transmission of a test report to the network node, the test report indicating at least a combination of tested operational parameters that provides a performance metric closest to the target performance metric; and after transmitting the test report, receiving from the network node a radio configuration defining a set of operational parameters of the terminal devices selected by the network node for the radio connection.

In an embodiment, the plurality of different combinations of operational parameters comprises operational parameters on a plurality of protocol layers, and wherein the means are configured to test performance of the plurality of different combinations of operational parameters on the plurality of protocol layers.

In an embodiment, the means are configured to determine a performance metric for each of the plurality of protocol layers, to combine the performance metrics on the plurality of protocol layers into a single performance metric, and to add the single performance metric to the test report.

In an embodiment, the set of operational parameters selected by the network node comprises the same operational parameters as comprised in the test report.

In an embodiment, at least one operational parameter is the same in the test report and in the set of operational parameters selected by the network node but has a different value in the test report than in the set of operational parameters selected by the network node.

In an embodiment, the means are configured to determine, during the testing that the apparatus cannot find a combination of operational parameters within the limitations that would meet the target performance metric and, in response to so determining, find a combination of operational parameters within the limitations that provides the closest match with the target performance metric, determine a performance metric for the combination of operational parameters that provides the closest match with the target performance metric and to insert the determined performance metric to the test report.

In an embodiment, the means are configured to transmit, before receiving the request, a message indicating capability for the radio configuration test to the network node.

In an embodiment, the means are configured to store a database comprising various combinations of operational parameters used in earlier radio connections and, for each combination of operational parameters, at least one performance metric, and to perform the radio configuration test by searching, from the database, the combination of tested operational parameters that provides a performance metric closest to the target performance metric.

In an embodiment, the request comprises a plurality of target performance metrics, and wherein the means are configured to test the plurality of different combinations of operational parameters, within the limitations received from the network node, to determine performance metrics of each of the plurality of different combinations of operational parameters, and to insert to the test report at least the combination of tested operational parameters that provides performance metrics closest to the target performance metrics.

In an embodiment, the means are configured to receive, from the network node, further requests for performing the radio configuration test for different target performance metrics, to perform the radio configuration test for the different target performance metrics and to perform the reporting separately for each request.

In an embodiment, the request is a part of reconfiguration of the radio connection and the target performance metric indicates a purpose of the reconfiguration, wherein the radio configuration also indicates the purpose, and wherein the means are configured to store the radio configuration as linked to the purpose and use the store configuration and the purpose in a later radio configuration test indicating the same purpose.

According to an aspect, there is provided an apparatus for a network node, comprising: transmitting, to a terminal device, a request for performing a radio configuration test for selecting operational parameters of the terminal device for a radio connection of the terminal device, the request comprising at least one information element indicating a target performance metric and at least one information element defining limitations to the operational parameters available for the radio configuration test; receiving, from the terminal device, a test report indicating at least a combination of tested operational parameters that provides a performance metric closest to the target performance metric; selecting, on the basis of the test report, a radio configuration defining a set of operational parameters for the radio connection; and causing transmission of at least one radio configuration message to the terminal device, the at least one radio configuration message comprising the set of operational parameters selected for the radio connection.

In an embodiment, the limitations limit the operational parameters available for the radio configuration test on a plurality of protocol layers.

In an embodiment, the means are configured to select the combination of tested operational parameters reported by the terminal device to provide the performance metric closest to the target performance metric as at least a part of the set of operational parameters for the radio connection.

In an embodiment, the means are configured to select, as the set of operational parameters selected by the network node, at least partially different operational parameters than the combination of tested operational parameters reported by the terminal device to provide the performance metric closest to the target performance metric.

In an embodiment, the test report comprises, in addition to the combination of tested operational parameters, a performance metric indicating performance of the combination of tested operational parameters with respect to the target performance metric, wherein the performance metric differs from the target performance metric, and wherein the means are configured to select the set of operational parameters for the connection further on the basis of the reported performance metric.

In an embodiment, the means are configured to receive, before transmitting the request, a message indicating capability of the terminal device for the radio configuration test, and to transmit the request in response to receiving the message.

In an embodiment, the request comprises a plurality of target performance metrics, and wherein the test report comprises at least the combination of tested operational parameters that provides performance metrics closest to the target performance metrics.

In an embodiment, the means are configured to transmit, to the terminal device, further requests for performing the radio configuration test for different target performance metrics, and to receive the test report separately for each request.

In an embodiment, means are configured to determine a need to reconfigure the radio connection and to transmit the request as a part of reconfiguration of the radio connection, wherein the target performance metric indicates a purpose of the reconfiguration.

In an embodiment, the means are further configured to perform a further radio configuration test by testing a further plurality of different combinations of operational parameters of the terminal device, to determine limitations to the further plurality of different combinations of the operational parameters and perform the further testing within the limitations at the network node, to determine a performance metric of each of the further plurality of different combinations of tested operational parameters, and to select the radio configuration on the basis of the further radio configuration test.

In an embodiment, the means comprises at least one processor and at least one memory including computer program code, wherein the at least one memory and computer program code are configured to, with the at least one processor, cause the performance of the apparatus.

According to an aspect, there is provided a method comprising: receiving, by a terminal device from a network node, a request for performing a radio configuration test for selecting operational parameters of the terminal device for a radio connection of the terminal device, the request comprising at least one information element indicating a target performance metric and at least one information element defining limitations to the operational parameters available for the radio configuration test; performing, by the terminal device the radio configuration test by testing a plurality of different combinations of operational parameters of the terminal device, within the limitations received from the network node, and determining, by the terminal device, a performance metric of each of the plurality of different combinations of tested operational parameters; transmitting, by the terminal device, a test report to the network node, the test report indicating at least a combination of tested operational parameters that provides a performance metric closest to the target performance metric; and after transmitting the test report, receiving by the terminal device from the network node a radio configuration defining a set of operational parameters of the terminal devices selected by the network node for the radio connection.

In an embodiment, the plurality of different combinations of operational parameters comprises operational parameters on a plurality of protocol layers, and wherein the terminal device tests performance of the plurality of different combinations of operational parameters on the plurality of protocol layers.

In an embodiment, the terminal device determines a performance metric for each of the plurality of protocol layers, combines the performance metrics on the plurality of protocol layers into a single performance metric, and adds the single performance metric to the test report.

In an embodiment, the set of operational parameters selected by the network node comprises the same operational parameters as comprised in the test report.

In an embodiment, at least one operational parameter is the same in the test report and in the set of operational parameters selected by the network node but has a different value in the test report than in the set of operational parameters selected by the network node.

In an embodiment, the terminal device determines, during the testing that the apparatus cannot find a combination of operational parameters within the limitations that would meet the target performance metric and, in response to so determining, finds a combination of operational parameters within the limitations that provides the closest match with the target performance metric, determines a performance metric for the combination of operational parameters that provides the closest match with the target performance metric and inserts the determined performance metric to the test report.

In an embodiment, the terminal device transmits, before receiving the request, a message indicating capability for the radio configuration test to the network node.

In an embodiment, the terminal device stores a database comprising various combinations of operational parameters used in earlier radio connections and, for each combination of operational parameters, at least one performance metric, and performs the radio configuration test by searching, from the database, the combination of tested operational parameters that provides a performance metric closest to the target performance metric.

In an embodiment, the request comprises a plurality of target performance metrics, and wherein the terminal device tests the plurality of different combinations of operational parameters, within the limitations received from the network node, determines performance metrics of each of the plurality of different combinations of operational parameters, and inserts to the test report at least the combination of tested operational parameters that provides performance metrics closest to the target performance metrics.

In an embodiment, the terminal device receives, from the network node, further requests for performing the radio configuration test for different target performance metrics, performs the radio configuration test for the different target performance metrics and performs the reporting separately for each request.

In an embodiment, the request is a part of reconfiguration of the radio connection and the target performance metric indicates a purpose of the reconfiguration, wherein the radio configuration also indicates the purpose, and wherein the means are configured to store the radio configuration as linked to the purpose and use the store configuration and the purpose in a later radio configuration test indicating the same purpose.

According to an aspect, there is provided a method, comprising: transmitting, by a network node to a terminal device, a request for performing a radio configuration test for selecting operational parameters of the terminal device for a radio connection of the terminal device, the request comprising at least one information element indicating a target performance metric and at least one information element defining limitations to the operational parameters available for the radio configuration test; receiving, by the network node from the terminal device, a test report indicating at least a combination of tested operational parameters that provides a performance metric closest to the target performance metric; selecting, by the network node on the basis of the test report, a radio configuration defining a set of operational parameters for the radio connection; and transmitting, by the network node, at least one radio configuration message to the terminal device, the at least one radio configuration message comprising the set of operational parameters selected for the radio connection.

In an embodiment, the limitations limit the operational parameters available for the radio configuration test on a plurality of protocol layers.

In an embodiment, the network node selects the combination of tested operational parameters reported by the terminal device to provide the performance metric closest to the target performance metric as at least a part of the set of operational parameters for the radio connection.

In an embodiment, the network node selects, as the set of operational parameters selected by the network node, at least partially different operational parameters than the combination of tested operational parameters reported by the terminal device to provide the performance metric closest to the target performance metric.

In an embodiment, the test report comprises, in addition to the combination of tested operational parameters, a performance metric indicating performance of the combination of tested operational parameters with respect to the target performance metric, wherein the performance metric differs from the target performance metric, and wherein the network node selects the set of operational parameters for the connection further on the basis of the reported performance metric.

In an embodiment, the network node receives, before transmitting the request, a message indicating capability of the terminal device for the radio configuration test and transmits the request in response to receiving the message.

In an embodiment, the request comprises a plurality of target performance metrics, and wherein the test report comprises at least the combination of tested operational parameters that provides performance metrics closest to the target performance metrics.

In an embodiment, the network node transmits, to the terminal device, further requests for performing the radio configuration test for different target performance metrics, and receives the test report separately for each request.

In an embodiment, the network node determines a need to reconfigure the radio connection and transmits the request as a part of reconfiguration of the radio connection, wherein the target performance metric indicates a purpose of the reconfiguration.

In an embodiment, the network node determines to perform a further radio configuration test by testing a further plurality of different combinations of operational parameters of the terminal device, to determine limitations to the further plurality of different combinations of the operational parameters and perform the further testing within the limitations at the network node, to determine a performance metric of each of the further plurality of different combinations of tested operational parameters, and to select the radio configuration on the basis of the further radio configuration test.

According to an aspect, there is provided a computer program product embodied on a computer-readable medium and comprising a computer program code readable by a computer, wherein the computer program code configures the computer to carry out a computer process in a terminal device, the computer process comprising: receiving, from a network node, a request for performing a radio configuration test for selecting operational parameters of the terminal device for a radio connection of the terminal device, the request comprising at least one information element indicating a target performance metric and at least one information element defining limitations to the operational parameters available for the radio configuration test; performing the radio configuration test by testing a plurality of different combinations of operational parameters of the terminal device, within the limitations received from the network node, and determining a performance metric of each of the plurality of different combinations of tested operational parameters; causing transmission of a test report to the network node, the test report indicating at least a combination of tested operational parameters that provides a performance metric closest to the target performance metric; and after transmitting the test report, receiving from the network node a radio configuration defining a set of operational parameters of the terminal devices selected by the network node for the radio connection.

According to an aspect, there is provided a computer program product embodied on a computer-readable medium and comprising a computer program code readable by a computer, wherein the computer program code configures the computer to carry out a computer process in a network node, the computer process comprising: transmitting, to a terminal device, a request for performing a radio configuration test for selecting operational parameters of the terminal device for a radio connection of the terminal device, the request comprising at least one information element indicating a target performance metric and at least one information element defining limitations to the operational parameters available for the radio configuration test; receiving, from the terminal device, a test report indicating at least a combination of tested operational parameters that provides a performance metric closest to the target performance metric; selecting, on the basis of the test report, a radio configuration defining a set of operational parameters for the radio connection; and causing transmission of at least one radio configuration message to the terminal device, the at least one radio configuration message comprising the set of operational parameters selected for the radio connection.

### LIST OF DRAWINGS

Embodiments are described below, by way of example only, with reference to the accompanying drawings, in which

FIG. 1 illustrates a wireless communication scenario to which some embodiments of the invention may be applied;

FIG. 2 illustrates a process for performing radio configuration testing in a terminal device according to an embodiment;

FIG. 3 illustrates a process for configuring a terminal device to perform radio configuration testing by a network node according to an embodiment;

FIG. 4 illustrates a signalling diagram of a radio configuration testing procedure;

FIG. 5 illustrates an effect of some embodiments using machine learning;

FIG. 6 illustrates another embodiment of a process for performing radio configuration testing; and

FIG. 7 and FIG. 8 illustrates a block diagram of a structure of an apparatus according to an embodiment.

### DESCRIPTION OF EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. A person skilled in the art will realize that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

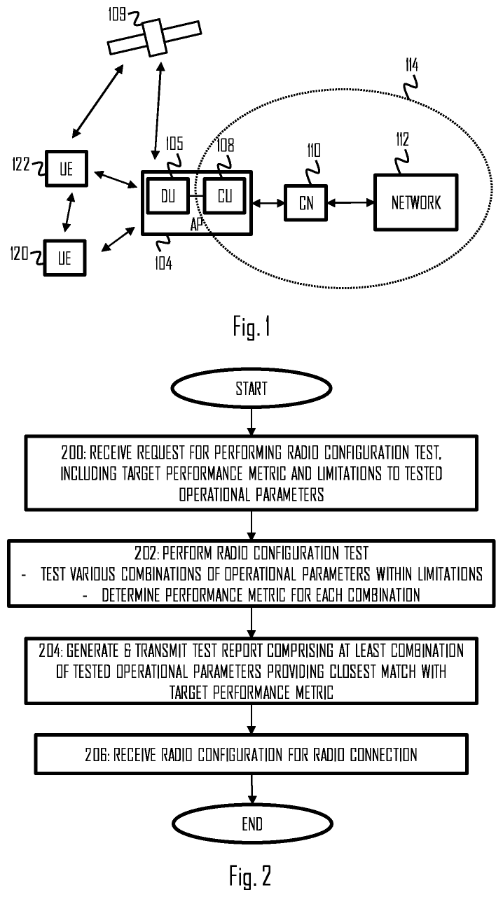

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows terminal devices or user devices 120 and 122 configured to be in a wireless connection on one or more communication channels in a cell with an access node (such as (e/g)NodeB) 104 providing the cell. (e/g)NodeB refers to an eNodeB or a gNodeB, as defined in 3GPP specifications. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used not only for signalling purposes but also for routing data from one (e/g)NodeB to another. The (e/g)NodeB is a computing device configured to control the radio resources of communication system it is coupled to. The NodeB may also be referred to as a base station, an access point, an access node, or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station. 5G specifications define two relay modes: out-of-band relay where same or different carriers may be defined for an access link and a backhaul link; and in-band-relay where the same carrier frequency or radio resources are used for both access and backhaul links. In-band relay may be seen as a baseline relay scenario. A relay node is called an integrated access and backhaul (IAB) node. It has also inbuilt support for multiple relay hops. IAB operation assumes a so-called split architecture having CU and a number of DUs. An IAB node contains two separate functionalities: DU (Distributed Unit) part of the IAB node facilitates the gNB (access node) functionalities in a relay cell, i.e. it serves as the access link; and a mobile termination (MT) part of the IAB node that facilitates the backhaul connection. A Donor node (DU part) communicates with the MT part of the IAB node, and it has a wired connection to the CU which again has a connection to the core network. In the multihop scenario, MT part (a child IAB node) communicates with a DU part of the parent IAB node.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input—multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and typically fully centralized in the core network. The low-latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 112, such as a public switched telephone network or the Internet, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 105) and non-real time functions being carried out in a centralized manner (in a centralized unit, CU 108).

It should also be understood that the distribution of functions between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or node B (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway, maritime, and/or aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 109 in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

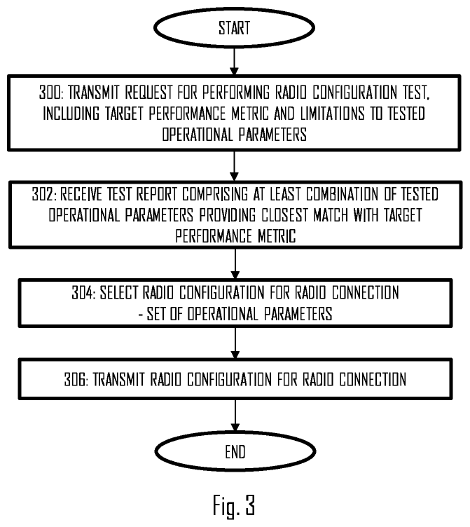

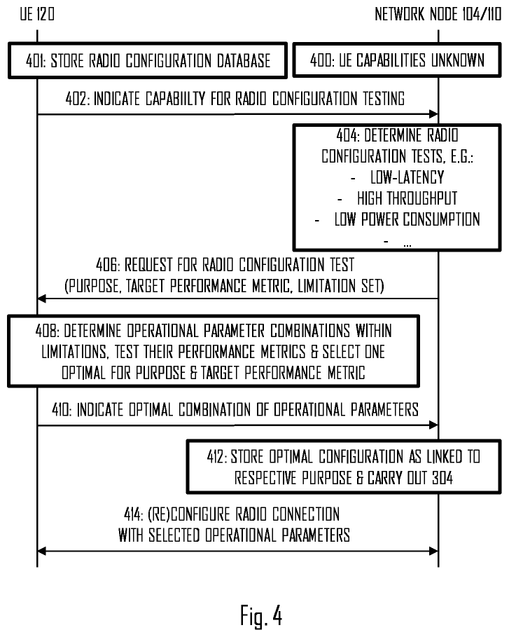

FIGS. 2 and 3 illustrated flow diagrams of methods for configuring a terminal device (UE) 120 or 122 for radio configuration testing. FIG. 2 illustrates a process carried out by an apparatus for the terminal device, and FIG. 3 illustrates a process carried out by an apparatus for a network node such as the access node 104 (DU or CU) or a network node of the core network 110. The network node of the core network may be a network node that manages non-access stratum parameters related to radio connections, e.g. an access and mobility management function (AMF), a session management function (SMF), or a policy control function (PCF) of a 5G network.

As described in background, the capabilities of the terminal devices increase constantly. It may not be feasible or even possible to inform the serving network node(s) of all the capabilities of the terminal device. Furthermore, each terminal device supporting the same capabilities on paper may experience different performance when using the same capabilities (operational parameters) during their radio connections, even under the same operating conditions due to differences in performance when multiple features within the terminal device are expected to interwork together, exposing some limitations due to the choice of the hardware and/or software architecture, which the network is not typically aware of. As the network is unaware of such limitations, it is unable to provide an optimal radio configuration, e.g. one that meets a required performance. The same problem may happen from the network side wherein the network does not support multiple-feature interworking, resulting in a radio configuration that is sub-optimal to be delivered to the terminal device because it does not exploit “real” capabilities of the terminal device. All in all, the problem of determining an optimal radio configuration is an intractable one, and machine-learning-based methods are useful and may be applied to optimize the radio configuration and the performance under a given set of performance criteria for a given deployment/scenario under a given set of mutual constraints of the network and the terminal device.

Referring to FIG. 2, the process performed in the terminal device comprises: receiving (block 200), from a network node, a request for performing a radio configuration test for selecting operational parameters of the terminal device for a radio connection of the terminal device, the request comprising at least one information element indicating a target performance metric and at least one information element defining limitations to the operational parameters available for the radio configuration test; performing (block 202) the radio configuration test by testing a plurality of different combinations of operational parameters of the terminal device, within the limitations received from the network node, and determining one or more performance metrics of each of the plurality of different combinations of tested operational parameters; causing (block 204) transmission of a test report (i.e. feedback) to the network node, the test report indicating at least a combination of tested operational parameters that provides one or more performance metrics closest to the target performance metrics; and after transmitting the test report, receiving (block 206) from the network node a radio configuration defining a set of operational parameters of the terminal devices selected by the network node for the radio connection.

Referring to FIG. 3, the process performed by the network node comprises: transmitting (block 300), to the terminal device, a request for performing a radio configuration test for selecting operational parameters of the terminal device for a radio connection of the terminal device, the request comprising at least one information element indicating a target performance metric and at least one information element defining limitations to the operational parameters available for the radio configuration test; receiving (block 302), from the terminal device, a test report indicating at least a combination of tested operational parameters that provides a performance metric closest to the target performance metric; selecting (block 304), on the basis of the test report, a radio configuration defining a set of operational parameters for the radio connection; and causing (block 306) transmission of at least one radio configuration message to the terminal device, the at least one radio configuration message comprising the set of operational parameters selected for the radio connection.

The feature of giving the terminal device(s) the possibility to find out the best solution to reach the target performance metric improves the performance of the terminal device(s). It may even reduce the signalling overhead in the sense that the network node needs not to be informed of the capabilities that it does not utilize in the radio connection. The feature of the network node making the selection on the basis of the test report enables the network node to take the test report into account but, optionally, still deviate from the operational parameters proposed by the terminal device in the test report. Accordingly, the network node may select the set of operational parameters on the basis of further criteria such as overall radio access network performance. This enables reaching a solution where the set of operational parameters serves both the terminal device and the network node in an advantageous manner (e.g., offering joint optimization of a radio configuration consistent with both network and UE capabilities).

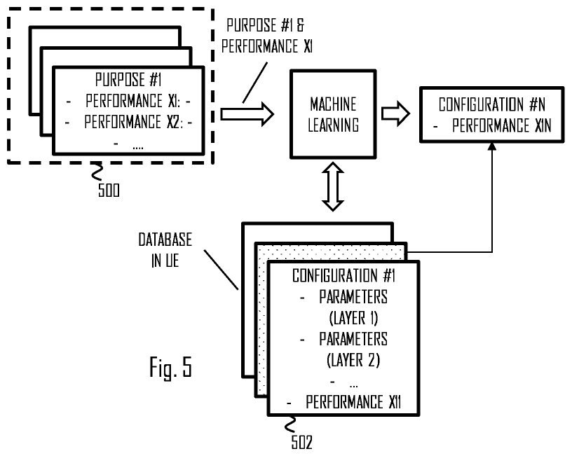

As indicated above, the network node needs not to be aware of the capabilities of the terminal device before starting the radio configuration test. The network may have no detailed knowledge of the radio capabilities of the terminal device. For example, the network node may be unaware of one or more of the following, exemplary capabilities of the terminal device: a number of transmitter/receiver chains or a number of spatial layers supported by the terminal device, frequency band and/or bandwidth(s) supported by the terminal device, measurement capabilities of the terminal device, and a number of antenna panels in the terminal device and optionally antenna panel switching capabilities). Since the capabilities are not known fully, the network node may be unaware of what kind of configuration messages are supported by the terminal device. Neither may the network node know which radio configurations would exploit the capabilities of the terminal device in an optimal manner, e.g. provide simultaneously the best performance from both network and terminal device perspective. FIG. 4 illustrates a signalling diagram of an embodiment for performing the radio configuration test. The procedure of FIG. 4 may be carried out at the beginning of a radio connection (radio resource control, RRC, connection), e.g. when establishing the RRC connection, or during the RRC connection when reconfiguration of the RRC connection is needed. The radio configuration test may be carried out in a case where the network node is about to determine static or semi-static radio configuration for the terminal device and for a certain purpose. The purpose may be ‘high-throughput radio configuration’, ‘low-latency configuration’, ‘measurement configuration’, ‘low power consumption configuration’, etc.

Referring to FIG. 4, the network node may be initially unaware of the capabilities of the terminal device for a radio connection (block 400). For the purpose of the radio configuration testing, the terminal device may store (block 401) a radio configuration database storing various combinations of operational parameters used in earlier radio connections of the terminal device (e.g., historical data gained from previous learning or experience from previous configurations in the field, manufacturer-determined configurations, configurations previously used in terminal testing, etc.). For each combination of operational parameters, the database may store at least one performance metric. Accordingly, the terminal device may have, for the purpose of the radio configuration test, knowledge of past radio configurations that have been used and respective performance metrics. Accordingly, as the terminal device operates, it improves the knowledge of its true capabilities and performance with various radio configurations. In theory, the terminal device may have been designed to provide a certain performance with a certain combination of operational parameters. However, due to errors in design, production, testing, etc. the performance may not be accurate. For example, a certain radio configuration may provide a poorer or better performance than what was designed, and the true performance of the various radio configurations can only be measured during the operation of the terminal device under various operational conditions that include some that cannot be foreseen during the testing (e.g., multiple feature interworking as mentioned earlier).

At a determined stage, the terminal device may indicate capability for performing the radio configuration test (step 402). This step may replace the conventional solution of reporting all the capabilities of the terminal device. As a consequence, instead of reporting all the capabilities, a flag or a short binary indicator may need to be transferred at this stage. Step 400 may be carried out during the establishment of the RRC connection, e.g. in a RRC setup message such as RRCSetupRequest or RRCSetupComplete or with a RRC message specified for the purposes of machine learning enabled training, or as part of another protocol layer (e.g. non-access stratum, NAS) message used for initiating radio configuration test.

Upon receiving the indication of the support for the radio configuration test, the network node may proceed with configuring the radio configuration test(s). In block 404, the network node may determine one or more radio configuration test setups. Each test setup may be for a specific purpose, e.g. those listed above and illustrated in FIG. 4 in block 402. Further purposes may be envisaged in a straightforward manner when considering the operational characteristics and requirements for the radio connections, and the list is by no means exhaustive. Each radio configuration test setup may comprise the purpose, at least one performance metric, and at least some limitations to the operational parameters suspected to the testing. Table 1 below illustrates an example of some test setups.

TABLE 1

| Test | | Performance | |
|---|---|---|---|
| setup ID | Purpose | metric(s) | Limitations |
| ID#1 | Low Latency | Latency | One spatial layer, |
| | | value T1 | packet size below |
| | | | P1, uplink |
| | | | configuration e.g. |
| | | | PUCCH, packet |
| | | | duplication |
| | | | configuration, |
| | | | timer values etc. |
| ID#2 | High Throughput | bit rate B1 | Bandwidth above |
| | | | BW1, number of |
| | | | antenna panels, |
| | | | number of |
| | | | transmit and |
| | | | receive chains |
| | | | (e.g. Carrier |
| | | | aggregation OR |
| | | | dual connectivity |
| | | | enabled), number |
| | | | of MIMO layers, |
| | | | used codebook |
| | | | configuration, |
| | | | used reference |
| | | | signal |
| | | | configuration, and |
| | | | modulation |
| ID#3 | Low Power | Maximum power | One spatial layer, |
| | Consumption | consumption PC1 | DRX periods, |
| | | | reductions to |
| | | | signalling, |
| | | | Bandwidth Part |
| | | | parameters e.g. |
| | | | number of |
| | | | bandwidth parts, |
| | | | channel |
| | | | bandwidth, |
| | | | configuration of |
| | | | downlink |
| | | | monitoring |
| ID#4 | Beam | Bit rate B1, Beam | Measurement |
| | measurement | switching failures | configuration is |
| | configuration | F1, Number of | the task that |
| | | beam switches S1 | contains several |
| | | | dimensions; |
| | | | measurement |
| | | | resources, |
| | | | periodicity, |
| | | | reporting |
| | | | configuration, |
| | | | quantities etc. |
| | | | which are part of |
| | | | the measurement |
| | | | and reporting |
| | | | configuration for |
| | | | beam |
| | | | management. |
| ID#5 | UL MIMO and | PA bandwidth | if a UE reports UL |
| | Intra band | BW1 | MIMO and Intra |
| | contiguous UL | | band contiguous |
| | CA | | UL CA for a band |
| | | | as UE capability |
| | | | and a network |
| | | | configures both, |
| | | | but if UE cannot |
| | | | use one of them, |
| | | | at least network |
| | | | can learn that one |
| | | | of the PAs covers |
| | | | a part of |
| | | | bandwidth of the |
| | | | CA. More |
| | | | specifically, when |
| | | | it comes to UL CA |
| | | | of |
| | | | 100 MHz + 100 MHz, |
| | | | suddenly that UE |
| | | | cannot use UL |
| | | | MIMO together |
| | | | with CA because |
| | | | each PA can cover |
| | | | only 100 MHz. So |
| | | | to use both UL |
| | | | MIMO and CA, |
| | | | each PA has to |
| | | | have an ability to |
| | | | cover 200 MHz. |
| | | | Practically, this |
| | | | happens because |
| | | | UL MIMO |
| | | | capability does |
| | | | not care about |
| | | | simultaneous CA |
| | | | usage. In this case, |
| | | | to pass UL MIMO |
| | | | requirement |
| | | | without UL CA, it |
| | | | is fine for each PA |
| | | | to cover up to |
| | | | 100 MHz for FR1. |

In Table 1, PUCCH refers to a physical uplink control channel, UL to uplink, CA to carrier aggregation, MIMO to multiple-input-multiple-output communication, and PA to a power amplifier of the terminal device.

The network node may determine the test setups for a default set of conventional operational scenarios common to the normal operation of the network node and the terminal device. The number of radio configuration tests carried out initially in connection with the RRC setup may be in the order of a dozen or a few dozens, e.g. less than 50. However, the network node may determine to carry out further radio configuration tests for yet untested purposes during the operation of the radio configuration. For example, the default test setups may cover those basic scenarios expected to occur in all or most RRC connections. Because of the complexity of the system, unexpected events and scenarios may occur and, upon detecting presence of such a scenario to which none of the tested radio configurations seem to provide a suitable solution, the network node may determine to run the further radio configuration tests to address such scenarios in the future. This may also include asking the terminal device to provide its “best” configuration for the current situation without a specific “purpose” from the network, allowing the terminal device to indicate the configuration it would like to have. In such a case, the network node may give the terminal device full freedom without any limitations in the request. Such a solution may be useful for cases where the network node cannot find a working radio configuration, e.g. even after one or more radio configuration tests, and further expands the “untested purposes”. In terms of machine learning, a machine learning algorithm of the terminal device may have the freedom to decide what to optimize for (the purpose and even the target performance metric).

After configuring at least one test setup, the network node may send the request for performing a radio configuration test to the terminal device in step 406. The request may comprise any one of the configured test setups, e.g. it may contain information elements comprising at least some information on a particular record (row) of Table 1. For example, if the test setup is for the purpose of low latency, the request may comprise the respective performance metric(s) and the limitations on the same record (row) of Table 1. Upon receiving the request, the terminal device may start the testing in block 408. The terminal device may determine the target performance metric and the limitations to the operational parameters and perform the radio configuration test. The terminal device may then search the database (stored in block 401) for radio configurations meeting the limitations. Any stored radio configuration comprising operational parameters not complying with the limitations may be excluded from the testing. Upon filtering the stored radio configurations to contain only the radio configurations complying with the limitations, the terminal device may search the performance metrics of the radio configurations and determine whether or not they include the same metric as the target performance metric. For example, if the target performance metric comprises the bit rate, the terminal device may filter out those radio configurations for which the particular performance metric is not available. However, the terminal device may store various performance metrics for each radio configuration so that they can be included in various types of radio configuration testing. Upon the further filtering, the terminal device may search for the radio configuration providing the best performance metric, e.g. the greatest bit rate. Thereafter, the terminal device may compare the best performance metric with the target performance metric.

Upon determining on the basis of the comparison that the best performance metric meets the target performance metric, the terminal device may determine the set of operational parameters linked to the best performance metric in the database and generate and send the test report comprising the set of operational parameters to the network node in step 410. In an embodiment, the test report comprises the best performance metric and/or an information element indicating that the set of operational parameters meets the target performance metric.

Upon determining on the basis of the comparison that the best performance metric does not meet the target performance metric, the terminal device may determine the set of operational parameters linked to the best performance metric in the database and generate and send the test report comprising the set of operational parameters to the network node in step 410. In this case, the test report may further comprise the best performance metric and/or an information element indicating that the set of operational parameters provides the best match with the target performance metric although it cannot meet the target performance metric. In other words, the terminal device may determine, during the testing that it cannot find a combination of operational parameters within the limitations that would meet the target performance metric and, in response to so determining, find a combination of operational parameters within the limitations that provides the closest match with the target performance metric, determine a performance metric for the combination of operational parameters that provides the closest match with the target performance metric, and insert the determined performance metric to the test report.

Upon determining that there are more than one set of operational parameters that provide a performance metric meeting or even exceeding the target performance metric, the terminal device may select a set of operational parameters that provides the greatest performance metric and generate and send the test report comprising the set of operational parameters to the network node in step 410. In this case, the test report may further comprise the best performance metric to indicate a gain over the target performance metric.

In summary, the terminal device may, upon performing the radio configuration test, indicate to the network node the set of operational parameters that are within the limitations and, further, indicate a performance loss or performance gain with respect to the target performance metric. When the number of target performance metrics in the test is greater than one, the indication may be for each target performance metric. The set of operational parameters indicated in the test report may be the one that provides the best aggregate performance across all the target performance metrics.

Upon receiving the test report in step 408, the network node may store the set of operational parameters as linked to the identifier and purpose of the radio configuration test. The set of operational parameters may be stored in a record indicating the operational parameters deemed optimal for the purpose by the terminal device. Thereafter, the network node may select the combination of operational parameters for the radio connection in block 412 (effectively block 304). When selecting the operational parameters for the radio connection, the network node may employ the operational parameters in the test report and, further, other factors. The other factors may include selection of operational parameters for other terminal devices, overall performance of the network node and a system comprising the network node and multiple terminal devices, such as terminal devices in a cell managed by the network node. As a consequence, the selected combination of operational parameters selected in block 412 may deviate from the ones indicated in the test report. Upon selecting the combination of operational parameters, the radio connection may be configured with the operational parameters in step 414. This may include transmitting the radio configuration to the terminal device and the terminal device implementing the radio configuration to its communication with the network node.

In an embodiment, the set of operational parameters selected by the network node in block 412/304 comprises the same operational parameters as comprised in the test report.

In another embodiment, at least one operational parameter is the same in the test report and in the set of operational parameters selected by the network node but has a different value in the test report than in the set of operational parameters selected by the network node. In other words, the network node may deviate from the set of operational parameters proposed by the terminal device in the test report. The reason may be consideration of the overall network performance, for example.

Steps 406 to 412 (or 414) may be repeated for the other radio test setups in the same manner. As described above, the network node may carry out a the radio configuration test to account for the various radio communication scenarios.

With respect to the limitations, the limitations may limit only a subset of operational parameters used in the testing. The terminal device may interpret the limitations such that it is free to test freely those operational parameters that are not limited by the limitations. For example, when the limitations do not limit the number of antenna panels or the bandwidth, the terminal device may perform the testing with all possible numbers of antenna panels and bandwidths it is capable of using in the testing. On the other hand, if the limitations limit the number of spatial streams to a certain number or range, the terminal device may be bound to include in the testing only those sets of operational parameters meeting the limitations, as described above.

In an embodiment, upon receiving the test report the network node may determine to carry out the radio configuration test for the same purpose again, but with a different (value of) target performance metric and/or the limitations. For example, if the terminal device reports that is provides a certain loss in the performance with respect to the target performance metric, the network node may decide to run the test again but with more liberal or at least changed limitations. Additionally, or alternatively, it may choose to use a different target performance metric and/or to drop the requirement set by the target performance metric to see, if the terminal device would be able to provide a better match with the target performance after the adjustment of the test setup. Accordingly, blocks 404 to 412 may be repeated for the radio configuration test of the particular purpose. In other words, upon performing the radio configuration test the network node may determine to perform a further radio configuration test for the same purpose by testing a further plurality of different combinations of operational parameters of the terminal device. The network node may determine limitations to the further plurality of different combinations of the operational parameters and perform the testing within the limitations, determine a performance metric of each of the plurality of different combinations of tested operational parameters, and select the radio configuration on the basis of the further radio configuration test.

As described above, the network node may have a preconfigured set of basic radio configuration tests for each terminal device. After running the basic radio configuration tests, the network node and the terminal device have learnt to communicate the most optimal radio configurations and respective sets of operational parameters that jointly satisfy capability constraints of both the terminal device and the network node. The radio configuration test may be understood as a discovery process for discovering the capabilities of the terminal device for the various purposes. Each radio configuration Rₓ that is tested and discovered has the characteristic that it has something special compared (or distinct) to another radio configuration R_{y}. The sequence of radio configuration tests and associated test reports form a set of radio configurations {R₁, R₂, R₃, R₄, Rₓ, R_{y} . . . Rₙ}, and the radio configuration testing may be understood as a lean radio configuration protocol between the network node and the terminal device learnt/tailored/form-fit for a given deployment scenario or communication purpose not comprising of the features that are not useful for the given communication scenario (e.g. factory automation scenario under low robot mobility but highly optimized for latency). The set of radio configurations may be aggregated in the network node to be a part of a dynamic configuration protocol. The network node may perform the radio configuration testing for a plurality of terminal devices served by the network node, and the network node may aggregate a radio configuration database for each terminal device. The radio configuration database may be updated as new terminal devices enter the network and as reconfigurations of the radio connections call for new radio configuration testing.

The steps 404 to 412 may be understood as a part of a communication loop between the network node and the terminal device. It is understood that as the network node communicates with a multitude of terminal devices with various capabilities and from different vendors, the terminal devices may be grouped in populations with similar capabilities/characteristics, and the network node may use the knowledge the inside a population to increase convergence towards a common set of operational parameters for a particular purpose and for a particular group of terminal devices deemed in the radio configuration tests to provide similar capabilities. Such a group of terminal devices may be from the same vendor or have specific hardware configurations configured for particular implementations.

In an embodiment, the limitations limit the set of operational parameters for the test on a plurality of protocol layers, and the terminal device tests, within the limitations, the operational parameters on the plurality of protocol layers. Such a multi-layer testing enables the terminal device to find out the set of operational parameters that provides the best overall performance and can overcome the sub-optimization that would be possible when evaluating only a particular protocol layer, e.g. a link layer. The plurality of protocol layers may include two or more of the three or four lowest protocol layers on a protocol stack of the terminal device: physical layer, medium access control (MAC) layer, radio link control (RLC) layer, and a packet data convergence protocol (PDCP) layer. As described above, the terminal device may store the radio configuration database, and records in the database may store operational parameters on the plurality of protocol layers for each radio configuration and set of operational parameters. Further, the stored performance metrics may comprise performance metrics on a plurality of protocol layers. As a consequence, the terminal device may determine a performance metric for each of the plurality of protocol layers, and to provide in the test report the plurality of performance metrics. In another embodiment, the terminal device combines the performance metrics on the plurality of protocol layers to a single performance metric, and to add the single performance metric to the test report. The implementation may depend on the target performance metric(s) comprised in the request received in step 406. If there are multiple target performance metrics on multiple protocol layers, the terminal device may report all performance metrics providing the closest match with the target performance metric. As described above, the closest match may be understood as the best one for the target performance metric, e.g. one that meets the target performance metric or, even better, provides the greatest performance over the target performance metric. On the other hand, if the request comprises a target performance metric on a particular protocol layer which is not the lowest one, the terminal device may aggregate to the performance metric the performance on the particular protocol layer such that the performance on the lower protocol layer(s) is also considered. For example, if there are two sets of operational parameters providing the same performance on the requested protocol layer, the terminal device may select, as the one inserted into the test report, the set of operational parameters providing better performance on the lower protocol layer(s). In such a case, the performance metric(s) describing the performance on the lower protocol layers needs not to be the same as the target performance metric on the requested protocol layer. For example, let us assume that the target performance metric is the bit rate on the PDCP layer. Two sets of operational parameters may meet the target bit rate, but the other one causes significantly higher power consumption on the physical layer, e.g. requires the use of an additional antenna panel. As a consequence, the terminal device may select the set of operational parameters meeting the target bit rate with the lower power consumption.

As described above, the request may comprise a plurality of target performance metrics, and the terminal device may test the plurality of different combinations of operational parameters, within the limitations received from the network node, determine performance metrics of each of the plurality of different combinations of operational parameters, and insert to the test report at least the combination of tested operational parameters that provides performance metrics closest to the target performance metrics.

As described above, the radio configuration test may be a part of reconfiguration of the radio connection and the target performance metric may indicate a purpose of the reconfiguration. For example, the network node may determine, during the operation of the radio connection, that the terminal device needs to reduce the number of spatial layers. However, the network node may wish to maintain the bit rate. Upon detecting that such a scenario has not been tested, the network node may generate, wherein the radio configuration also indicates the purpose, and wherein the means are configured to store the radio configuration as linked to the purpose and use the store configuration and the purpose in a later radio configuration test indicating the same purpose. The purpose may be indicated by the values of the target performance metric. For example, if an earlier radio configuration test was performed with respect to a certain value of the bit rate, and a new radio configuration test also defines the bit rate as the target performance metric but with a different value, the terminal device may determine that the purpose is to increase/decrease the bit rate. In another embodiment, the request may specify the purpose explicitly, e.g. increase/decrease the bit rate. Upon determining the purpose, the terminal device may search for a new set of operational parameters that address the requested purpose and still provide a suitable performance in view of other performance metrics of the terminal device. For example, if the purpose is to increase the bit rate, the terminal device may find a set of operational parameters that provides the increased data rate with the lowest increase in the power consumption.

In the embodiments where the test report comprises, in addition to the combination of tested operational parameters, a performance metric indicating performance of the combination of tested operational parameters with respect to the target performance metric, wherein the performance metric differs from the target performance metric, the network node may select the set of operational parameters for the radio connection further on the basis of the reported performance metric. In particular when the terminal device is incapable of meeting the target performance metric, adding the performance metric related to the proposed set of operational parameters tells the network node how far from the target performance the terminal device is. As a consequence, the network node may use the different between the performance metrics in determining whether or not to rerun the radio configuration test with different limitations. If the difference is greater than a certain threshold, the rerun may be triggered. Otherwise, the network node may proceed to block 304.

The above-described embodiments provide the terminal device with machine learning capabilities for monitoring its operation and performance and for finding the sets of operational parameters for particular use cases that are not limited by any fixed combinations of operational parameters. Let us then describe an example scenario where the proposed learning mechanism allows the network node to identify multi-panel capabilities of the terminal device. The multi-panel capabilities may include a number of simultaneously active antenna panels in the terminal device form transmission and/or reception, a panel switching delay, etc. The network node may send the request for performing a radio configuration test for testing beam measurements and reporting and a target performance metric of “bit-rate”. The configuration for beam measurement and reporting may contain a configuration parameter such as “simultaneous beam reception reporting-enabled” and “multiple beam groups-enabled” to be considered in the reporting of simultaneous beam reception via multiple antenna panels. Upon receiving the request, the terminal device may make an assessment of the request and check it against the loss/gain in “bit-rate” performance metric. If the terminal device does not have multiple panels or a capability for activating multiple panels for transmission/reception, the terminal device may learn that it cannot meet the request and report. The terminal device may in such a case send a test report indicating the incapability of performing the radio configuration test. In a case where the terminal device supports has multiple antenna panels and is capable of receiving via multiple antenna beams and via multiple beam groups but that the pas experience of the terminal device is that such a simultaneous reception does not improve the bit rate, the terminal device may provide in the test report a single-beam reception that meets the target performance metric, if the target performance can be reached.

Accordingly, in a case where the terminal device cannot meet the target performance metric within the set limitations but could meet it when deviating from the limitations. Therefore, the terminal device may include in the test report the set of operational parameters that would meet the target performance metric but deviates from the set limitations of the radio configuration test. In the abovce example, based on the assessment at the terminal device, the terminal device may suggest updates for the configuration for beam measurement and reporting such as “simultaneous beam reporting-disabled” and indicating the best “beam group” for maximizing performance metric “bit-rate”.

As another example, if the terminal device has a single panel or panel switching timing is large, the terminal device may learn from earlier radio configurations that it should not change the beam when using multiple “beam groups” and prefer a single “beam group” that improves performance metric “bit-rate”. The network node may thus learn at least the following based on the test report: the terminal device does not have the capability of multiple panel reception (based on the “simultaneous beam reporting-disabled”), the best set of radio beams, “beam group” to serve the terminal device such that ‘bit-rate’ is maximized, and the terminal device does not have capability for dynamic switch of panels with low latency or it has only one panel (based on the indication of best “beam group). In an embodiment, upon discovering the incapability of the terminal device to meet the limitations, the network node may trigger the further radio configuration test with the changed limitations.

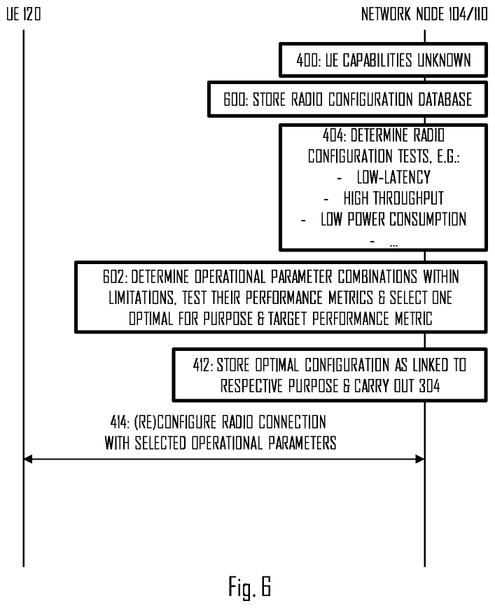

FIG. 5 illustrates the purpose and effect of the radio configuration test. Referring to FIG. 5, the network node may store, for each terminal device, a database storing records of the operational parameters for specific purposes and respective target performance metric(s). Initially, the database is empty from the sets of operational parameters suitable for the respective purposes. On the other hand, the terminal device stores the radio configuration database 502 storing sets of operational parameters used in the earlier radio connections and respective performance metrics, optionally on multiple protocol layers. The network node may at this stage be unaware of the database 502, while the terminal device is not aware of the database 500. Upon determining to find the set of operational parameters suitable for the terminal device for a specific purpose, the network node may initiate the radio configuration test and perform the test setup for the purpose (purpose #1 in FIG. 5) and retrieve the required target performance metrics from the database 500. The retrieved target performance metrics may form a subset of target performance metrics for the purpose, e.g. bit rate X1 may be included but bit rate X2 may be excluded. In general, only one target performance metric value per target performance metric type may be selected for one test setup. The network node may also determine the limitations for the testing, as described above. Then, the network node may send the request and subject the terminal device to use the machine learning to perform the testing. According to any one of the above-described embodiment, the terminal device may find the set of operational parameters (configuration #N in this case) that meets the target performance metric. Accordingly, the network node becomes aware of the capabilities of the terminal device for the specific purpose and may store the respective set of operational parameters in the configuration database 500. Accordingly, the database 500 becomes updated with the true capabilities of the terminal device for the various purposes.

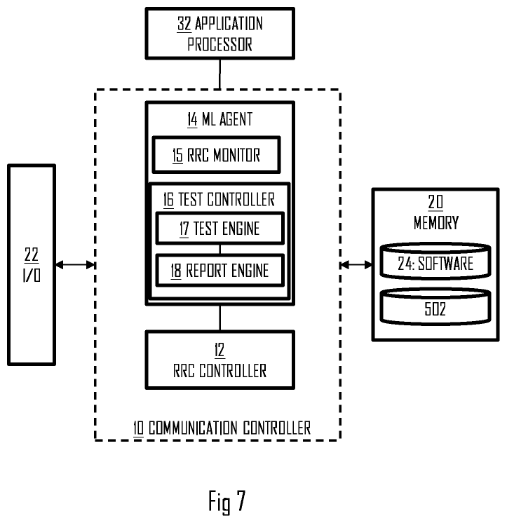

In an embodiment, the network node may store the capabilities of the terminal device learnt in the earlier radio connections and respective performance metrics. The performance metrics may be measured and stored in the network node and/or received from the terminal device. Accordingly, the network node may be capable of performing the testing on behalf of the terminal device. FIG. 6 illustrates such an embodiment.

Accordingly, the apparatus for the network may carry out a method comprising: generating a test setup for performing a radio configuration test for selecting operational parameters of the terminal device for a radio connection of the terminal device, the test setup comprising at least one information element indicating a target performance metric and at least one information element defining limitations to the operational parameters available for the radio configuration test; performing the radio configuration test by testing a plurality of different combinations of operational parameters of the terminal device, within the limitations received from the network node, and determining a performance metric of each of the plurality of different combinations of tested operational parameters; generating a test report indicating at least a combination of tested operational parameters that provides a performance metric closest to the target performance metric; selecting, on the basis of the test report, a radio configuration defining a set of operational parameters for the radio connection; and causing transmission of at least one radio configuration message to the terminal device, the at least one radio configuration message comprising the set of operational parameters selected for the radio connection.

Referring to FIG. 6, the network node may store in block 600 the radio configuration database that contains at least partially same information as the radio configuration database described above as maintained in the terminal device. The network node may not be aware of all the possible operational parameters of the terminal device, even after numerous radio connections. However, the knowledge may be sufficient to perform at least the basic set of radio configuration tests for the basic purposes. Creating the test setup may be similar to that described above in connection with block 404. Then, the network node may perform ion block 602 substantially the same machine learning functions, as described above in connection with block 408. With the knowledge of the operational parameters used by the terminal device and respective performance metrics, the network node may be capable of simulating or emulating the performance of the terminal device under the various sets of operational parameters. The test report may also be generated in the above-described manner as an output of block 602. Obviously, the transfer of the test report is now internal to the network node and follows internal information transfer protocols, e.g. application programming interface protocols. Then, blocks 412 and 414 may be carried out in the above-described manner. Accordingly, some of the radio configurations may be tested only in the network node, some only in the terminal device, and some in both. For example, if the network node deems that it cannot reach a suitable performance by testing on its own, it may trigger the process of FIG. 4 to configure the terminal device, having better insight of its capabilities, to carry out the testing.

In an embodiment, the process of FIG. 6 is combined with the process of FIG. 4, i.e. the radio configuration testing is performed in both the terminal device and in the network node. For example, the network node may carry out the basic set of radio configuration tests and supplement them with enhanced testing caried out in the terminal device.

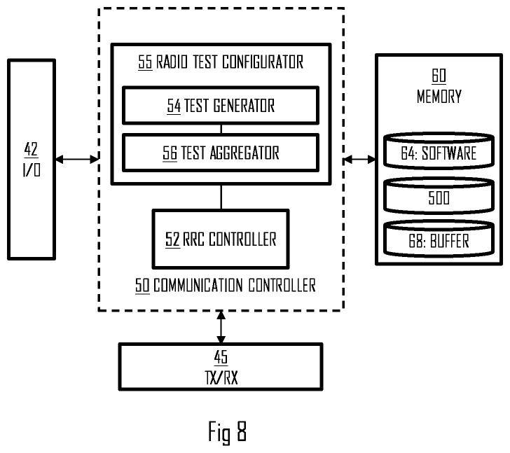

FIG. 7 illustrates an apparatus comprising means for carrying out the process of FIG. 2 or any one of the embodiments described above. The apparatus may comprise at least one processor 10 and at least one memory 20 including a computer program code (software) 24, wherein the at least one memory and the computer program code (software) are configured, with the at least one processor, to cause the apparatus to carry out the process of FIG. 2 or any one of its embodiments described above. The apparatus may be for the terminal device of the cellular communication system. The apparatus may be a circuitry or an electronic device realizing some embodiments of the invention in the terminal device. The apparatus carrying out the above-described functionalities may thus be comprised in the terminal device, e.g. the apparatus may comprise a circuitry such as a chip, a chipset, a processor, a micro controller, or a combination of such circuitries for the terminal device.

The memory 20 may be implemented using any suitable data storage technology, such as semiconductor-based memory devices, flash memory, magnetic memory devices and systems, optical memory devices and systems, fixed memory and removable memory. The memory may store the radio configuration database 502 and a computer program code (software) configuring the operation of the one or more processors or processing circuitries of the apparatus.

In an embodiment, the apparatus comprises at least one processor, the at least one memory 20, and the computer program code that configure the apparatus to carry out the process of FIG. 2 or any one of the embodiments thereof. The at least one processor may comprise a communication controller 10. The communication controller 10 may comprise an RRC controller 12 configured to establish, manage, and terminate radio connections, e.g. the RRC connections. The RRC controller 12 may be configured, for example, to establish and reconfigure the RRC connections. The RRC controller may perform the step 414, for example.

The communication controller 10 may further comprise a machine learning (ML) agent 14 configured to carry out the process of FIG. 2 or any one of the embodiments thereof. The ML agent 14 may comprise, as sub-circuitries or sub-modules defined by physical circuits or combinations of the physical circuits and software 24, a RRC monitor 15 configured to monitor the operational parameters of radio connections, measure respective performance metrics thereof, and to maintain the database 502 as new radio configurations are taken into use or as performance metrics of previously used radio configurations change. The ML agent 14 may further comprise a test controller 16 configured to carry out the radio configuration testing according to the procedure of FIG. 2 or 4, for example. The test controller may comprise a test engine configured to determine the test configuration, e.g. the target performance metric(s) and the sets of operational parameters (radio configurations) to be included in the testing. Thereafter, the test engine may carry out the testing and determine one or more sets of operational parameters that provide the closest match with the target performance metric(s). As described above, the closest match may mean the set of operational parameters that provide the best solution in terms of the target performance metric and the limitations. The test controller may further comprise a report engine configured to generate and transmit the test report to the network node.

The apparatus may further comprise a communication interface 22 comprising hardware and/or software for providing the apparatus with radio communication capability, as described above. The communication interface 22 may include, for example, an antenna, one or more radio frequency filters, a power amplifier, and one or more frequency converters. The communication interface 22 may comprise hardware and software needed for realizing the radio communications over the radio interface, e.g. according to specifications of an LTE or 5G radio interface.

FIG. 8 illustrates an apparatus comprising a processing circuitry, such as at least one processor, and at least one memory 60 including a computer program code (software) 64, wherein the at least one memory and the computer program code (software) are configured, with the at least one processor, to cause the apparatus to carry out functions of the network node 104 or 110 in the process of FIG. 3 or any one of its embodiments described above. The apparatus may be for the network node of the cellular network infrastructure. The apparatus may be a circuitry or an electronic device realizing some embodiments of the invention in the network node. The apparatus carrying out the above-described functionalities may thus be comprised in such a device, e.g. the apparatus may comprise a circuitry such as a chip, a chipset, a processor, a micro controller, or a combination of such circuitries for the network node. In other embodiments, the apparatus is the network node. The at least one processor or a processing circuitry may realize a communication controller 50 controlling communications with terminal devices over the radio interface in the above-described manner. The communication controller may be configured to establish and manage radio (RRC) connections and transfer of data over the radio connections.

The communication controller 50 may comprise an RRC controller 52 configured to establish, manage, and terminate radio connections with terminal devices served by the access node. The RRC controller 52 may be configured, for example, to establish and reconfigure the RRC connections with the terminal devices.

The communication controller 50 may comprise a radio test configurator 55 configured to carry out the process of FIG. 3 or any one of the embodiments thereof. The RRC controller may enable the radio test configurator upon receiving the indicating that the terminal device supports the radio configuration testing, or upon determining to carry out the process of FIG. 7. The radio test configurator may comprise a test generator 54 configured to carry out block 404 and, optionally, block 406. The radio test configurator may in some embodiments comprise a similar test engine as described above for the terminal device. The radio test configurator may further comprise a test aggregator 56 configured to receive the test report(s) from the terminal device(s). The radio test configurator may then carry out block 412 and select the operational parameters for the radio connection. The RRC controller 52 may then carry out step 414 and (re)configure the radio connection of the terminal device.

The memory 60 may be implemented using any suitable data storage technology, such as semiconductor-based memory devices, flash memory, magnetic memory devices and systems, optical memory devices and systems, fixed memory and removable memory. The memory 60 may comprise the database 500 and, in some embodiments, a data buffer 68 for data communicated with the terminal devices.

The apparatus may further comprise a radio frequency communication interface 45 comprising hardware and/or software for providing the apparatus with radio communication capability with the terminal devices, as described above. The communication interface 45 may include, for example, an antenna array, one or more radio frequency filters, a power amplifier, and one or more frequency converters. The communication interface 42 may comprise hardware and software needed for realizing the radio communications over the radio interface, e.g. according to specifications of an LTE or 5G radio interface.

The apparatus may further comprise another communication interface 42 for communicating towards the core network. The communication interface may support respective communication protocols of the cellular communication system to enable communication with other access nodes, with other nodes of the radio access network, and with nodes in the core network and even beyond the core network. The communication interface 42 may comprise necessary hardware and software for such communications.

As used in this application, the term ‘circuitry’ refers to one or more of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present. This definition of ‘circuitry’ applies to uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described in FIG. 2, 3, or any of the embodiments thereof may also be carried out in the form of one or more computer processes defined by one or more computer programs. The computer program(s) may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

Embodiments described herein are applicable to wireless networks defined above but also to other wireless networks. The protocols used, the specifications of the wireless networks and their network elements develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. Embodiments are not limited to the examples described above but may vary within the scope of the claims.

1. An apparatus for a terminal device, comprising at least one processor and at least one memory including computer program code, wherein the at least one memory and computer program code are configured to, with the at least one processor, cause the apparatus to:
receive, from a network node, a request for performing a radio configuration test for selecting operational parameters of the terminal device for a radio connection of the terminal device, the request comprising at least one information element indicating a target performance metric and at least one information element defining limitations to the operational parameters available for the radio configuration test;
performing the radio configuration test by testing a plurality of different combinations of operational parameters of the terminal device, within the limitations received from the network node, and determining a performance metric of each of the plurality of different combinations of tested operational parameters;
cause transmission of a test report to the network node, the test report indicating at least a combination of tested operational parameters that provides a performance metric closest to the target performance metric; and
after transmitting the test report, receive from the network node a radio configuration defining a set of operational parameters of the terminal devices selected by the network node for the radio connection.

2. The apparatus of claim 1, wherein the plurality of different combinations of operational parameters comprises operational parameters on a plurality of protocol layers, and wherein the apparatus is configured to test performance of the plurality of different combinations of operational parameters on the plurality of protocol layers.

3. The apparatus of claim 2, wherein the apparatus is configured to determine a performance metric for each of the plurality of protocol layers, to combine the performance metrics on the plurality of protocol layers into a single performance metric, and to add the single performance metric to the test report.

4. The apparatus of claim 1, wherein the set of operational parameters selected by the network node comprises the same operational parameters as comprised in the test report.

5. The apparatus of claim 1, wherein at least one operational parameter is the same in the test report and in the set of operational parameters selected by the network node but has a different value in the test report than in the set of operational parameters selected by the network node.

6. The apparatus of claim 1, wherein the means apparatus is configured to determine, during the testing that the apparatus cannot find a combination of operational parameters within the limitations that would meet the target performance metric and, in response to so determining, find a combination of operational parameters within the limitations that provides the closest match with the target performance metric, determine a performance metric for the combination of operational parameters that provides the closest match with the target performance metric and to insert the determined performance metric to the test report.

7. The apparatus of claim 1, wherein the apparatus is configured to transmit, before receiving the request, a message indicating capability for the radio configuration test to the network node.

8. The apparatus of claim 1, wherein the apparatus is configured to store a database comprising various combinations of operational parameters used in earlier radio connections and, for each combination of operational parameters, at least one performance metric, and to perform the radio configuration test by searching, from the database, the combination of tested operational parameters that provides a performance metric closest to the target performance metric.

9. The apparatus of claim 1, wherein the request comprises a plurality of target performance metrics, and wherein the apparatus is configured to test the plurality of different combinations of operational parameters, within the limitations received from the network node, to determine performance metrics of each of the plurality of different combinations of operational parameters, and to insert to the test report at least the combination of tested operational parameters that provides performance metrics closest to the target performance metrics.

10. The apparatus of claim 1, wherein the apparatus is configured to receive, from the network node, further requests for performing the radio configuration test for different target performance metrics, to perform the radio configuration test for the different target performance metrics and to perform the reporting separately for each request.

11. The apparatus of claim 1, wherein the request is a part of reconfiguration of the radio connection and the target performance metric indicates a purpose of the reconfiguration, wherein the radio configuration also indicates the purpose, and wherein the apparatus is configured to store the radio configuration as linked to the purpose and use the store configuration and the purpose in a later radio configuration test indicating the same purpose.

12. An apparatus for a network node, comprising at least one processor and at least one memory including computer program code, wherein the at least one memory and computer program code are configured to, with the at least one processor, cause the apparatus to:
transmit, to a terminal device, a request for performing a radio configuration test for selecting operational parameters of the terminal device for a radio connection of the terminal device, the request comprising at least one information element indicating a target performance metric and at least one information element defining limitations to the operational parameters available for the radio configuration test;
receive, from the terminal device, a test report indicating at least a combination of tested operational parameters that provides a performance metric closest to the target performance metric;
select, on the basis of the test report, a radio configuration defining a set of operational parameters for the radio connection; and
cause transmission of at least one radio configuration message to the terminal device, the at least one radio configuration message comprising the set of operational parameters selected for the radio connection.

13. The apparatus of claim 12, wherein the limitations limit the operational parameters available for the radio configuration test on a plurality of protocol layers.

14. The apparatus of claim 12, wherein the apparatus is configured to select the combination of tested operational parameters reported by the terminal device to provide the performance metric closest to the target performance metric as at least a part of the set of operational parameters for the radio connection.

15. The apparatus of claim 12, wherein the apparatus is configured to select, as the set of operational parameters selected by the network node, at least partially different operational parameters than the combination of tested operational parameters reported by the terminal device to provide the performance metric closest to the target performance metric.

16. The apparatus of claim 12, wherein the test report comprises, in addition to the combination of tested operational parameters, a performance metric indicating performance of the combination of tested operational parameters with respect to the target performance metric, wherein the performance metric differs from the target performance metric, and wherein the apparatus is configured to select the set of operational parameters for the connection further on the basis of the reported performance metric.

17. The apparatus of claim 12, wherein the apparatus is configured to receive, before transmitting the request, a message indicating capability of the terminal device for the radio configuration test, and to transmit the request in response to receiving the message.

18. The apparatus of claim 12, wherein the request comprises a plurality of target performance metrics, and wherein the test report comprises at least the combination of tested operational parameters that provides performance metrics closest to the target performance metrics.

19. The apparatus of claim 12, wherein the apparatus is configured to transmit, to the terminal device, further requests for performing the radio configuration test for different target performance metrics, and to receive the test report separately for each request.

20-22. (canceled)

23. A method comprising:
receiving, by a terminal device from a network node, a request for performing a radio configuration test for selecting operational parameters of the terminal device for a radio connection of the terminal device, the request comprising at least one information element indicating a target performance metric and at least one information element defining limitations to the operational parameters available for the radio configuration test;
performing, by the terminal device the radio configuration test by testing a plurality of different combinations of operational parameters of the terminal device, within the limitations received from the network node, and determining, by the terminal device, a performance metric of each of the plurality of different combinations of tested operational parameters;
transmitting, by the terminal device, a test report to the network node, the test report indicating at least a combination of tested operational parameters that provides a performance metric closest to the target performance metric; and
after transmitting the test report, receiving by the terminal device from the network node a radio configuration defining a set of operational parameters of the terminal devices selected by the network node for the radio connection.

24-44. (canceled)
